(19) United States
(12) Patent Application Publication
(10) Pub. No.: US 2010/0033970 A1
(43) Pub. Date: Feb. 11, 2010

(54) Lighting Device with Variable Angle of Emission

(75) Inventors: Rainer Jetter, Marzling (DE); Ines Nikolaus, Hoerlkofen (DE); Harald Ries, Munich (DE); Andreas Timinger, Munich (DE)

Correspondence Address: HOUSTON ELISEEVA, 4 MILITIA DRIVE, SUITE 4, LEXINGTON, MA, 02421, US

(73) Assignee: OEC AG, Muenchen (DE)

(21) Appl. No.: 12/537,762

(22) Filed: Aug. 7, 2009

(30) Foreign Application Priority Data
Aug. 8, 2008 (DE) 10 2008 037 054.1

(51) Int. Cl. F21S 8/00

(52) U.S. Cl. 362/268

(57) ABSTRACT

A lighting device with variable angle of emission includes a light source, and a lens system comprising two lenses, a primary lens and a secondary lens. The two lenses and the light source are arranged along an optical axis and the distance between the primary lens and the secondary lens is variable, in order to vary the angle of emission of the cone of light rays generated by the lighting device. In one example, the primary lens has a numerical aperture of at least 0.7, the primary lens is an aplanat, and the secondary lens is designed so as to image to infinity, at a certain distance of the secondary lens from the primary lens, a virtual image of the light source generated by the primary lens. According to a second aspect, the illumination factors are distinguished by the fact that the primary lens has a numerical aperture of at least 0.7, and that the secondary lens may be moved by a distance extending in a range in which the secondary lens does not capture the whole of the cone of light rays generated by the primary lens.

### RELATED APPLICATIONS

This application claims priority to German Patent Application No. DE 10 2008 037 054.1, filed on Aug. 8, 2008, which is incorporated herein by reference in its entirety.

### BACKGROUND OF THE INVENTION

DE 199 01 391 A1 discloses a headlight with variable angle of emission. This headlight comprises a light source, a reflector assigned to the light source, a first condenser lens located in the light path in the direction of emission of the light source-reflector combination, and a second condenser lens located in the light path between the light source and the first condenser lens. In this headlight the first lens, which forms the basic lens of the headlight, is an aspherical lens. Preferably this lens is grained on at least one face.

EP 0 846 913 B1 discloses a similar headlight, which is distinguished by the fact that the distance between the light source and the reflector is variable.

Such headlights have proved to be very successful in practice, since their angle of emission can be adjusted over a wide range. As light source, such headlights use mainly filament lamps with a small filament. These known headlights are not suitable for the use of light-emitting diodes, since the latter have insufficient light output.

In using light-emitting diodes as the light source it would be desirable if the source were attenuated as little as possible, despite a variable angle of emission.

Ernst Abbe (1840 to 1905) was the first to discover that an image for which the spherical aberration is corrected, and which simultaneously meets a specific sine condition, is free from primary coma. Such a system is also described as aplanatic, although this term is used in different ways. In the following, the correction of the spherical aberration and Abbe's sine condition will be described by the term “aplanatic condition”.

The aplanatic conditions were introduced at an early stage as design criteria in imaging optics. Lens systems and lenses which meet this condition are also described as aplanats.

Imaging optics are in opposition to non-imaging optics or lighting optics, which may be defined to the effect that they relate to optical elements of which it is known how they map an edge of a light ray concentration from a source on to an edge of a light ray concentration of a target (Harald Ries et al: “Edge-Ray principle of non-imaging optics”, Optical Society of America, volume 11, no. 10, October 1994, page 2627 ff.).

WO 2006/020574 A1 discloses a flashlight with a light source. The light source generates a real image using two lenses. A further lens is provided, mounted so as to be slidable relative to the two other lenses, so that the emitted cone of light rays has an adjustable aperture angle. In one position of the movable lens, the real image of the light source is imaged to infinity.

Disclosed in DE 10 2006 059 434 A1 is a lens system with a multiplicity of lenses, in which condenser lenses close to the object are approximately aplanatic in form.

US 2005/0174768 A1 discloses a lighting system that has several light-emitting diodes of different colour in order to mix their light into a common cone of light rays.

EP 1 890 076 A1 describes a lighting device with a light-emitting diode and a lens that is able to guide nearly all the light of the light-emitting diode on to an area to be illuminated. The lens is mounted so as to slide relative to the light-emitting diode, in order to adjust the aperture angle.

WO 2007/017617 A1 discloses a lighting device which has as its light source a light-emitting diode, a first graduated lens and a second graduated lens. The second graduated lens is movable relative to the first graduated lens and the light-emitting diode, so that the aperture angle of the cone of light may be adjusted.

German patent DE 1 165 514 relates to an axially-symmetrical condenser lens which images a point of light virtually or to infinity, free from spherical aberration.

### SUMMARY OF THE INVENTION

The present invention relates to a lighting device with variable angle of emission.

Aspects of the present invention concern creating a lighting device with variable angle of emission, in which the most even distribution of light intensity possible is obtained over the greatest possible range of variation of the angle of emission.

In general according to one aspect, the invention features a lighting device with variable angle of emission with a light source and a lens system comprising two lenses, a primary lens and a secondary lens, for directing or concentrating the light emitted from the light source into a cone of light rays, wherein the two lenses and the light source are arranged along an optical axis and the primary lens is located between the light source and the secondary lens, and the distance between the primary lens and the secondary lens along the optical axis is variable, in order to vary the angle of emission of the cone of light rays, wherein the primary lens has a numerical aperture of at least 0.7, the primary lens is an aplanat, and the secondary lens is designed so as to image to infinity, at a certain distance of the secondary lens from the primary lens, a virtual image of the light source generated by the primary lens.

Aspects of the present invention also concern the creation of a lighting device with which on the one hand a strong, or large, variation of the angle of emission is possible, while on the other hand yet a predetermined minimal efficiency is obtained with a large angle of emission.

In general according to one aspect, the invention features a lighting device with variable angle of emission with a light source and a lens system comprising two lenses, a primary lens and a secondary lens, for directing or concentrating the light emitted from the light source into a cone of light rays, wherein the two lenses and the light source are arranged along an optical axis and the primary lens is located between the light source and the secondary lens, and the distance between the primary lens and the secondary lens along the optical axis is variable, in order to vary the angle of emission of the cone of light rays, wherein the primary lens has a numerical aperture of at least 0.7, that the secondary lens may be moved by a distance extending in a range in which the secondary lens does not capture the whole of the cone of light rays generated by the primary lens.

In general according to another aspect, the lighting device with variable angle of emission according to the invention has a light source and a lens system. The lens system comprises two lenses, a primary lens and a secondary lens, by means of which light emitted from the light source is directed or concentrated into a cone of light rays. The two lenses and the light source are arranged along an optical axis, and the primary lens is located between the light source and the secondary lens. The primary lens is located at a distance from the light source, and the distance between the primary lens and the secondary lens may be varied along the optical axis, in order to vary the angle of emission of the cone of light rays.

According to the first aspect of the present invention, the lighting device is distinguished by the fact that the primary lens has a numerical aperture of at least 0.7, the primary lens is in the form of an aplanat, and the secondary lens is designed so that it images into infinity a virtual image of the light source, at a specific distance of the secondary lens from the primary lens.

Because the primary lens is an aplanat, the light intensity distribution is imaged in the far field, i.e. a luminous flux of a specific solid angle is imaged on to another solid angle, while the relationship of the solid angle of a specific luminous flux not yet imaged to the solid angle of the imaged luminous flux is constant. If the light source is a homogeneous Lambertian source then the imaging of the light intensity distribution by means of an aplanat produces a cone of light rays which in turn represents Lambertian sources confined to a specific solid angle. If the secondary lens is mounted very close to the primary lens, then the secondary lens has scarcely any effect on the cone of light rays, so that the entire lens system produces a cone of light rays with roughly the property of a Lambertian source, and therefore has a broadly constant luminous flux per solid angle in the overall solid angle which is illuminated.

If the secondary lens is mounted at the predetermined distance from the primary lens, then the virtual light source will be optically imaged on a predetermined image plane which it is intended should be illuminated. If the light source is a flat Lambertian source, as is more or less the case with light-emitting diodes, then an irradiance distribution according to the cos⁴ law results. Because of the small angle of emission of the cone of light rays, the cos⁴ effect is negligible, so that a substantially uniform illumination intensity is obtained.

Here the image plane is to infinity. In small optical systems of this kind, a distance of e.g. 5 meters (m) may already be regarded as infinity.

The primary lens is an aplanat. In the present disclosure, the term “aplanat” is used to describe a lens that is corrected aplanatically in a certain arrangement relative to the light source. By this means a small light source is imaged free from coma and free from spherical aberration. The coma and the spherical aberration are the dominant imaging errors in the case of lenses with a high aperture. Consequently, the primary lens generates an exact virtual image of the light source. This exact virtual image can accordingly be imaged by the secondary lens. The provision of an aplanat as primary lens leads to considerably better imaging of the light source than with a primary lens which is not aplanatic, since on the one hand the maximum possible concentration (bundling), and on the other hand uniform illumination, are obtained. The efficiency and the evenness of the illumination of the cone of light rays produced by the lighting device are therefore optimized.

Consequently, with the lighting device according to aspects of the invention, on the one hand the light intensity distribution of the light source is imaged on a target, and on the other hand the light source itself is imaged on the target. In the imaging of the light intensity distribution, a cone of light rays with a large aperture angle is generated, which has the properties of a Lambertian source and a high light intensity in the centre, and a decreasing light intensity towards the outside. Through optical imaging, even illumination of the target is ensured. The optical imaging of the light source produces a very sharply bounded cone of light rays, whereas in the imaging of the light intensity distribution there is a gradual decline in light intensity outwards, roughly in line with the cos⁴ principle.

The intermediate zone between the two “imaging extremes” represents a mixed state between these two images in which there is a gradual transition from the sharply focused cone of light rays to a wider cone of light rays, with an increasingly strong gradient of light intensity from the inside to the outside. A significant advantage over conventional light source is that there is always a high light intensity in the centre of the cone of light rays. This is a significant benefit since, in the case of known light sources with variable angle of emission, because of geometrical effects there is generally for a certain area of the angle of emission a considerable reduction in light intensity in the centre. Such a dark spot is perceived as very disadvantageous by the human eye. This is reliably prevented by making the primary lens an aplanat.

The lighting device is especially advantageous when a light-emitting diode or a light source with similar properties to those of a light-emitting diode is used, since in the imaging by means of an aplanat, the light intensity distribution of a Lambertian source, homogeneous over the angular range, is imaged on to another angular range. In this process the homogeneity of the light intensity distribution is maintained and, in the optical imaging of the light source, the even illumination of the flat-surfaced emitting surface is imaged on the target.

According to the second aspect of the present invention, the secondary lens is able to slide over a distance extending in a range in which the secondary lens does not cover the whole of the cone of light rays generated by the primary lens. It is true that this has the consequence that the efficiency and the overall luminous flux of the light ray concentration or beam emitted by the lighting device reduces since a portion of the light output is no longer captured by the secondary lens. However, in the case of such large distances between the primary lens and the secondary lens, in which the secondary lens does not cover the whole of the cone of light rays generated by the primary lens, there is a very strong concentration of the light ray beam or bundle emitted by the lighting device, which makes the light intensity very high. It has been shown that, while the overall quantity of light of the cone of light rays reduces with increasing concentration, the light intensity remains constant, since essentially only the solid angle areas lying in the peripheral zone are faded out by the increasing concentration. Because the secondary lens is able to slide in a range in which the cone of light rays produced by the primary lens is no longer captured completely, it is possible to focus extremely highly the cone of light rays emitted by the lighting device.

A widening of the cone of light rays is obtained by pushing the secondary lens closer to the primary lens. By this means, from a certain distance between the primary lens and the secondary lens onwards, the entire cone of light rays is captured by the secondary lens. Through this, in the case of a wider cone of light rays, the whole of the quantity of light captured by the primary lens is used in the emitted cone of light rays. The quantity of light captured by the primary lens is determined by its numerical aperture, which is at least 0.7. Owing to the high level of efficiency of the optical system, outstanding light intensity is obtained even with a widened cone of light rays.

Under both aspects of the present invention, the numerical aperture of the primary lens is preferably at least 0.8, in particular at least 0.85 or 0.9.

Preferably the light-emitting diodes are of the type which emit white light.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1a, 1b show all optically active elements of a lighting device according to the present invention;

FIG. 1c shows a primary lens of the lighting device of FIGS. 1a and 1b, in cross-section;

FIGS. 2a, 2b show all optically active elements of a further lighting device according to the present invention;

FIG. 2c shows a primary lens of the lighting device of FIGS. 2a and 2b, in cross-section;

FIG. 3 shows an enlarged view of the light-emitting diode, primary lens and a ring diaphragm of the lighting device according to FIGS. 2a and 2b;

FIG. 4 shows a preferred form of a condenser lens section of the primary lens in a sectioned view together with a light-emitting diode;

FIGS. 5a-5c show in each case a primary lens and a secondary lens at different distances from one another, together with the light intensity distributions in the far field obtained by this means;

FIGS. 6a-6c show in each case a primary lens and a secondary lens at different distances from one another, together with the light intensity distributions in the far field obtained by this means

FIGS. 7a, 7b show a table of the coordinates of the entrance surface and the exit surface respectively of the condenser lens section shown in FIG. 4.

### DETAILED DESCRIPTION OF THE PREFERRED EMBODIMENTS

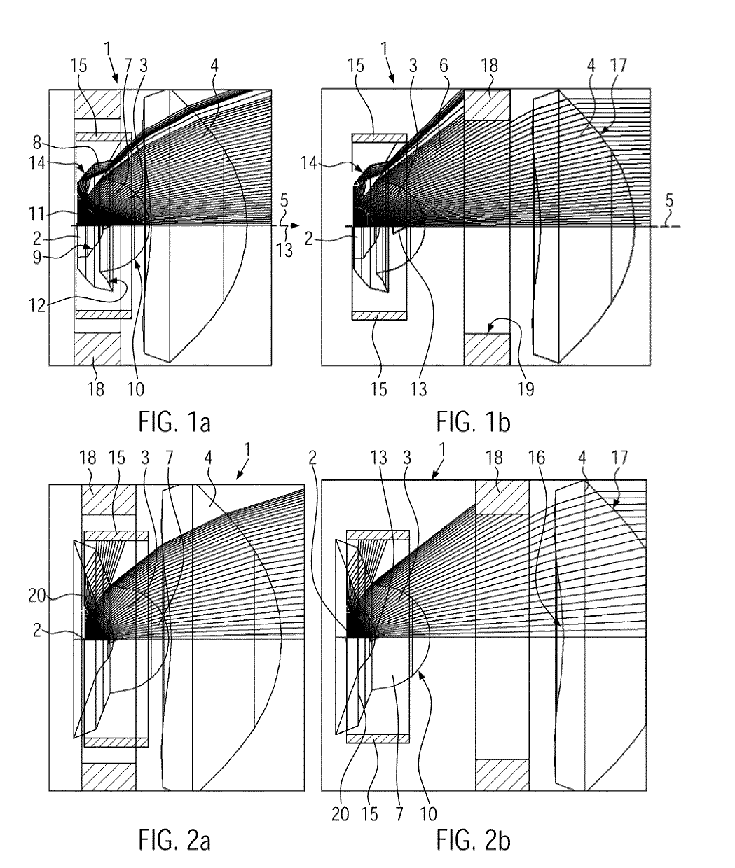

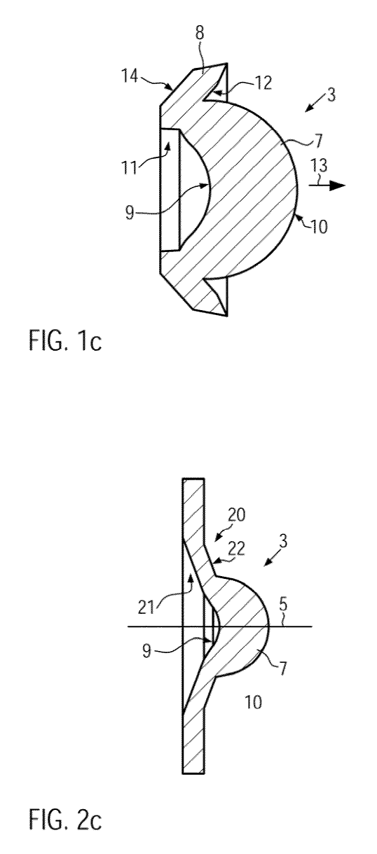

A first embodiment of the lighting device 1 according to the invention (FIGS. 1a, 1b, 1c) has as light source 2 a light-emitting diode.

The light-emitting diodes are e.g. a LUXEON Rebel from Phillips Lumileds Lighting Company.

Adjacent to the light-emitting diode is a primary lens 3 for concentrating the cone of light rays emanating from the light-emitting diodes. The lighting device 1 also has a secondary lens 4, which is mounted some distance from the primary lens 3. The light source 2, the primary lens 3 and the secondary lens 4 are each arranged along an optical axis 5, with the primary lens 3 and the secondary lens 4 being rotation-symmetric to the optical axis 5.

The primary lens 3 and the secondary lens 4 concentrate the light emitted by the light source 2. The secondary lens 4 is able to slide along the optical axis 5, by which means the angle of the cone of light rays 6 emitted from the lighting device 1 may be varied. In principle it is the case that the closer the secondary lens 4 is mounted to the primary lens 3, the more the cone of light rays 6 is widened, and the further the secondary lens 4 is mounted from the primary lens 3, the more the cone of light rays is concentrated. Further below, however, an example will be explained in which this correlation is not entirely made.

In what follows, the angle of emission of a cone of light rays will be understood to mean the angle between the optical axis to which the cone of light rays is approximately rotation-symmetric, and a boundary line of the cone of light rays. The angle of emission is therefore half the angle of the full widening of the cone of light rays.

In the present embodiment, the primary lens 3 is formed of two sections, namely a central condenser lens section 7 and a totally reflecting annular lens section 8.

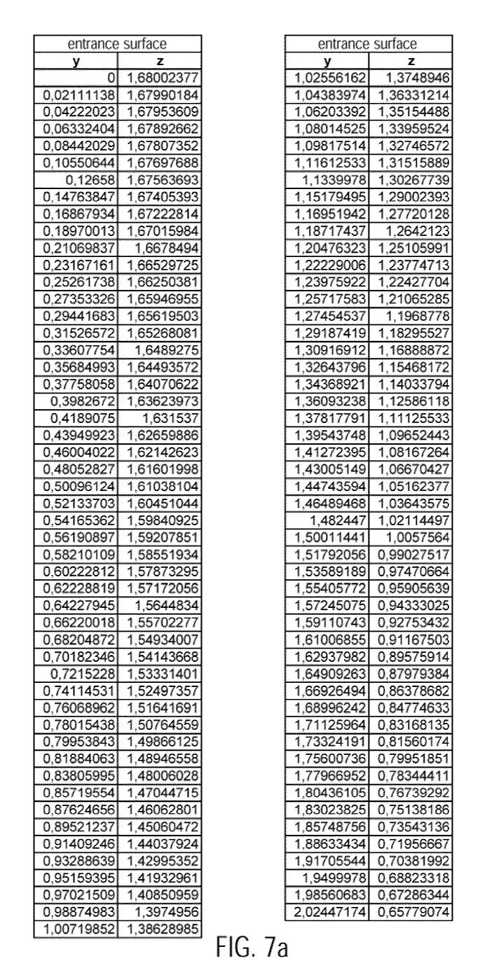

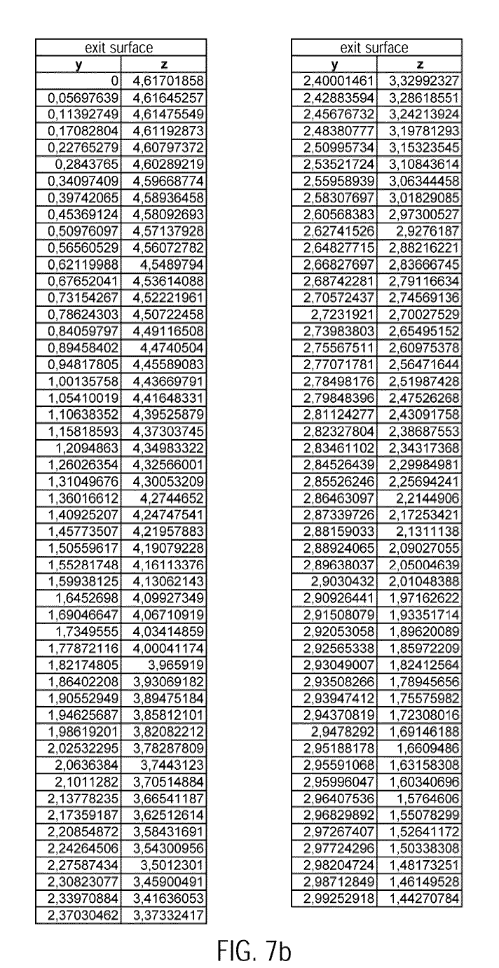

The condenser lens section 7, which is shown separately in FIG. 4, has a concave entrance surface 9 and a convex exit surface 10. This condenser lens section 7 represents an aplanat. The coordinates of the profile of the entrance surface 9 and the exit surface 10 are listed in the tables of FIGS. 7 and 8. This condenser lens section has a numerical aperture of 0.951 for a light source located in the point of origin of the coordinate system shown in FIG. 4. With regard to the arrangement of the light source at the point of origin of this coordinate system, this condenser lens section is aplanatically corrected.

With optical design programs obtainable in the market, such as e.g. CODEV, approximately aplanatic lenses may be calculated which allow a numerical aperture up to around 0.90. Such “approximated” aplanats are also suitable for realising the lighting device 1 according to aspects of the invention.

The annular lens section 8 has an entrance surface 11 and an exit surface 12. The entrance surface 11 extends roughly from the edge of the entrance surface 9 of the condenser lens section 7 towards the light source 2, while the entrance surface 11 of the annular lens section 8 has roughly the shape of a cylinder. Formed radially outside the entrance surface 11, on the annular lens section 8, is a sheath section 14, widening in the direction of emission 13, at which the light rays entering the annular lens section 8 through the entrance surface 11 are totally reflected to the exit surface 12. By means of the annular lens section 8, the light emission is captured outside the numerical aperture of the focusing lens section 7, and deflected forwards in the direction of emission 13. The entrance surface 11 and the exit surface 12 are aspherical surfaces.

The primary lens 3 is surrounded by a ring diaphragm 15, which screens off light scattered at right-angles to the optical axis 5.

The secondary lens 4 is a further focusing lens with a concave entrance surface 16 and a convex exit surface 17.

The secondary lens 4 has a pinhole diaphragm 18 which is located adjacent to the entrance surface 16 of the secondary lens 4, and its aperture 19 is so designed that the cone of light rays emanating from the primary lens is limited in such a way that only light striking the entrance surface 16 of the secondary lens 4 passes through the pinhole diaphragm 18. Light which would bypass the secondary lens 4 is absorbed by the pinhole diaphragm 18. The aperture 19 of the pinhole diaphragm 18 has a greater diameter than the circumference of the ring diaphragm 15 of the primary lens 3 so that, in the position in which the secondary lens is immediately adjacent to the primary lens 3, the pinhole diaphragm 18 concentrically encompasses the ring diaphragm 15 (FIG. 1a). In the position in which the secondary lens 4 is at the maximum distance from the primary lens 3 (FIG. 1b), the secondary lens is in this embodiment so designed that a virtual image of the light source 2 imaged by the primary lens is imaged to infinity. This means that all light rays emerging from the light source at the point of intersection with the optical axis 5 are deflected by the refraction effects at the primary lens and the secondary lens to form a cone of light ray concentration with parallel light rays or beam. In this process, the light is concentrated to the maximum extent. Since the light source 2 has a finite extent, a cone of light rays with low aperture is generated.

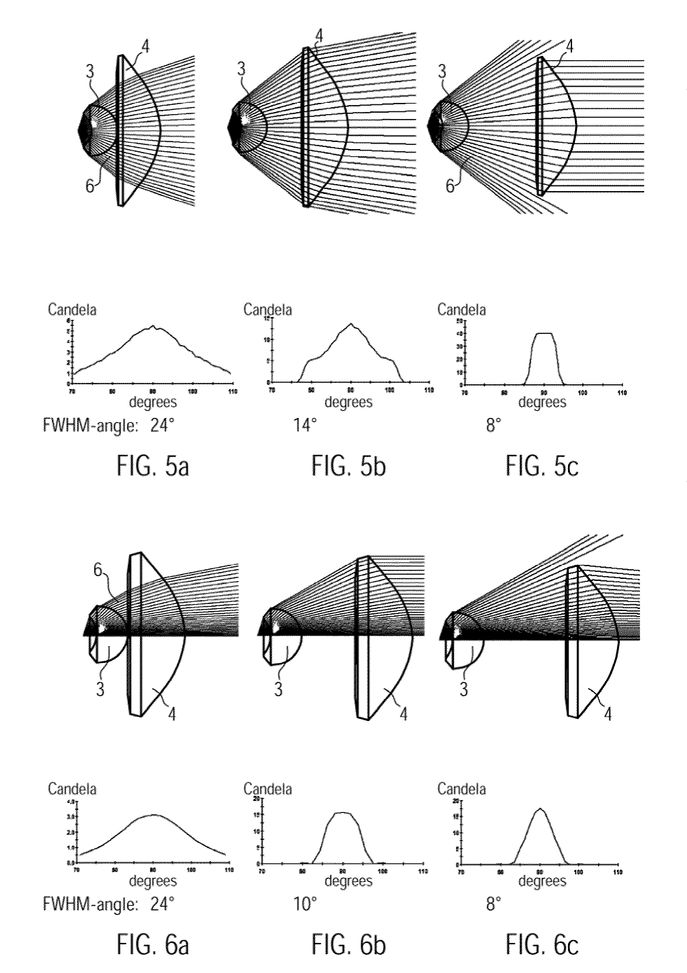

FIGS. 5a and 5b show in schematic form the primary lens and the secondary lens at different distances from one another, together with the course of the light rays. In FIG. 5a the secondary lens 4 is located directly at the primary lens. The cone of light rays generated has a full half-width of 24 degrees. In FIG. 5b the secondary lens 4 is located at a distance from the primary lens 3 calculated so that the entrance surface 16 of the secondary lens 4 is illuminated completely by the cone of light rays emitted by the primary lens, but no light bypasses the secondary lens 4. The cone of light rays generated in this way has a half-width of 14° in the far field. According to FIG. 5c, the secondary lens 4 is located at the maximum distance from the primary lens 3, at which an imaging of the light source 2 to infinity is generated. The half-width of the cone of light rays generated in this way comes to 8°. A portion of the light emitted by the primary lens 3 bypasses the secondary lens 4. In this arrangement, a portion of the luminous flux emitted by the primary lens 3 is dispensed with. Due to its very high concentration, the cone of light rays has high light intensity. If the secondary lens 4 is moved closer to the primary lens 3, then the cone of light rays generated becomes wider, so that more light is captured by the secondary lens 4. In this way it is possible to ensure that, even with a wide cone of light rays, a minimum light intensity is obtained at least in the central section of the cone of light rays.

In an alternative variant of the first embodiment, the secondary lens 4 is so designed that the lighting device 1 images the light source to infinity when the secondary lens 4 is just fully illuminated at its entrance surface 16 (FIG. 6b). By this means, a half-width of only 10° is obtained in the light intensity distribution in the far field of the cone of light rays. With a further increase in the distance between the secondary lens 4 and the primary lens 3, the cone of light rays may be even more concentrated, while dispensing with that portion of the luminous flux which bypasses the edge of the secondary lens 4. The light intensity distribution in the far field of the cone of light rays has in each case a half-width of 8°. This corresponds to the half-width of the embodiment shown in FIG. 5c, by which the light source is imaged to infinity. From the pattern of the light intensity distribution it is possible to see that, in the course of the imaging to infinity (FIG. 5c), the flanks decline more steeply, so that almost the whole luminous flux is concentrated in the angular range of approx. 85° to 95°, whereas with “over-collimation” in accordance with FIG. 6c, the flanks fall away less steeply so that the entire luminous flux is distributed over a larger angular range, even though the half-width is identical at 8°.

In what follows, the arrangement of the secondary lens 4 directly at the primary lens 3 (FIGS. 5a, 6a) is described as minimum distance layout and the arrangement of the secondary lens 4 at maximum distance from the primary lens 3 as maximum distance layout. The arrangement in which the cone of light rays 6 exactly covers the entrance surface 16 of the secondary lens 4, so that an increase in the distance between the secondary lens 4 and the primary lens 3 would result in a portion of the light rays bypassing the secondary lens 4, is described below as the covering layout (FIGS. 5b, 6b).

The secondary lens 4 may be so designed as to optically image the light source 2 in the covering layout or in the maximum distance layout or at a position of the secondary lens 4 between the covering layout and the maximum distance layout, i.e. the light source is imaged to infinity or the cone of light rays is collimated. Such a collimated cone of light rays is sharply bounded. This may also be recognized from the light intensity distributions shown in FIGS. 5c and 6b. The transition from a light intensity distribution declining gradually and radially outwards to a sharply defined cone of light rays is relatively abrupt.

The etendue (geometrical flux) is a maintenance value of optical systems. It is used to describe the geometrical capability of an optical system to allow the passage of light. The numerical value of the etendue is calculated as the product of the aperture size and the projected solid angle from which the system absorbs light. The value of the etendue (E) of a light source is calculated as follows:

E=n²·A·π·sin²(α),

in which n is the refractive index of the medium surrounding the light source, A the illuminating surface of the light source and α the angle of emission of the light source. For a light-emitting diode with an area of 1 mm², an auxiliary lens with n=1.4 and an angle of emission of 90°, the etendue value is 6.16.

The value of the etendue for the cone of light rays of the optical system of the lighting device is calculated by the following formula:

E=n²·d²·π/4·sin²(β)π,

in which d is the diameter of the primary lens and β the aperture angle of the generated cone of light rays.

This formula applies provided that the secondary lens captures completely the cone of light rays allowed through by the primary lens.

For a diameter d of the primary lens of 17.7 millimeters (mm) and n=1, the minimum aperture angle β will be 5.1°. Greater concentration is possible only if less light is absorbed by the lens system. With the primary lens shown in FIGS. 1a, 1b, 1c and 4, an aperture angle of 72° was realised, corresponding to a numerical aperture of 0.95. This gives an efficiency of 90%.

With a lens diameter of 17.7 mm it is thus possible through maintenance of the etendue to have a minimum angle of emission of β greater than 4.8°. If a smaller angle of emission is desired, then the absorbed luminous flux must be further reduced. In the embodiment of the present invention described above, this is obtained dynamically in the variant according to FIGS. 5a to 5c, also in the variant according to FIGS. 6a to 6c, by providing that a portion of the light in the area between the covering layout and the maximum distance layout is screened off, because it is not captured by the secondary lens. This reduces the value of the etendue, so that a smaller angle of emission is possible. With the lighting device in which the primary lens 3 is provided with the condenser lens section 7 shown in FIG. 4, a concentration of the cone of light rays of 4° was obtained with a primary lens diameter of 17.7 millimeters (mm). In this lighting device, the adjustment distance between the minimum distance layout and the maximum distance layout was 7.4 mm.

The aperture angle of 72° is condensed or concentrated by the primary lens 3 to a cone of light rays with an angle of emission of 38°. The maximum angle of emission in the minimum distance layout comes to 38°. This maximum angle of emission is determined substantially by the concentration of the primary lens 3, since the effect of the secondary lens 4 in the minimum distance layout on the cone of light rays is low.

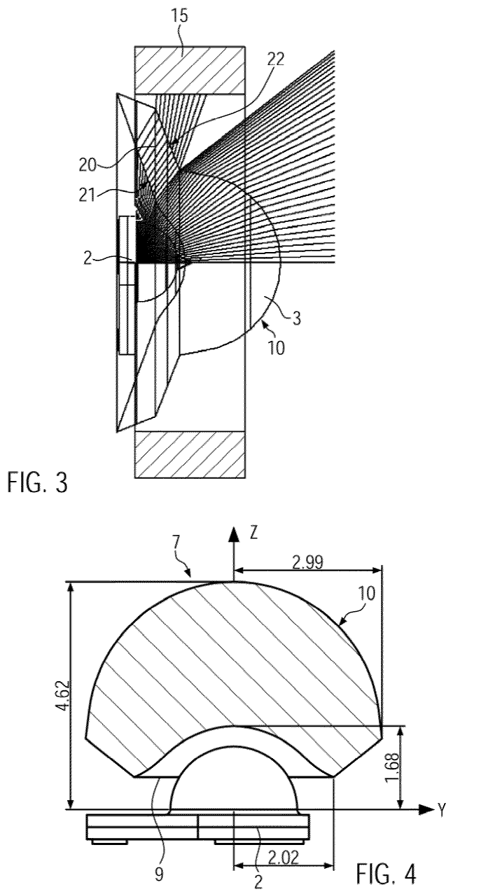

FIGS. 2a, 2b, 2c and 3 show a second embodiment of the lighting device 1. This embodiment corresponds substantially to the first embodiment, and identical parts with identical reference numbers are not explained again. The second embodiment differs from the first embodiment only in the design of the primary lens 3. The primary lens 3 of the second embodiment has at the point of the annular lens section a deflecting ring section 20, with an entrance surface 21 and an exit surface 22. The entrance surface 21 and the exit surface 22 are arranged roughly parallel to one another and run from the focusing lens section 7 radially outwards under an acute angle from the optical axis 5 against the direction of emission 13. The light rays entering at the entrance surface 21 are so deflected by the deflecting ring section 20 that they strike against the ring diaphragm 15, where they are absorbed. This ensures that no stray light from the boundary zone reaches the outside.

The suppression of stray light is especially advantageous when arrays of light sources, primary lenses and secondary lenses are provided, in which each of the primary lenses 3 is assigned a light source 2, and is mounted statically relative to the light source 2. Each of the secondary lenses 4 is assigned a primary lens 3, and all secondary lenses may be moved together. Each primary lens 3 is surrounded by a ring diaphragm 15. Mounted adjacent to the secondary lenses 4 is the pinhole diaphragm 18, which has an aperture 19 for each secondary lens 4. The pinhole diaphragm 18 is moved together with the secondary lens 4. With such an array of lighting devices according to the invention, a headlight or spotlight with high light intensity may be created, with an angle of emission which is variable over a wide range.

To obtain a round spot, each of the light-emitting diodes of such an array is rotated around an angle. The angles of rotation are preferably so distributed in space that similar angles of rotation are as far from one another as possible. When light-emitting diodes of the same type are used, one light-emitting diode i is rotated around the angle i·Z/N, with i denoting the number of the light-emitting diode, N the overall number of light-emitting diodes, and Z the smallest angular period after which the light-emitting diode surface once more coincides with the non-rotated light-emitting diode surface.

By this means, therefore, a strongly concentrated or focused headlight or spotlight with a uniformly round spot is created. The diaphragms 15, 18 also prevent the escape of stray light, which is a drawback with a strongly focused cone of light rays. The generated light ray cone range of 38° to 4° may be set with such a headlight or spotlight.

Both the first and also the second embodiment are suitable for creating such an array of lighting devices. The second embodiment is however preferred, since here stray light is avoided reliably.

Such an array of lighting devices with “rotated” light-emitting diodes is in particular advantageous in combination with light-emitting diodes of different colour. In a prototype, light-emitting diodes with the colours red, green and blue were used, each mounted alternately in the array. The alternate mounting of the different coloured light-emitting diodes and the rotating arrangement of the individual light-emitting diodes resulted in a good mixing of the differently coloured light ray concentrations (bundles). This produced an overall light ray concentration of a homogeneous colour, with this colour being variable in a controlled manner solely through the electrical activation of the differently coloured light-emitting diodes.

### LIST OF REFERENCE NUMBERS

1 lighting device

2 light source

3 primary lens

4 secondary lens

5 optical axis

6 cone of light rays

7 focusing lens section

8 annular lens section

9 entrance surface

10 exit surface

11 entrance surface

12 exit surface

13 direction of emission

14 sheath section

15 ring diaphragm

16 entrance surface

17 exit surface

18 pinhole diaphragm

19 aperture

20 deflecting ring section

21 entrance surface

22 exit surface

While this invention has been particularly shown and described with references to preferred embodiments thereof, it will be understood by those skilled in the art that various changes in form and details may be made therein without departing from the scope of the invention encompassed by the appended claims.

What is claimed is:

1. A lighting device with variable angle of emission, comprising:
a light source; and
a lens system comprising two lenses, a primary lens and a secondary lens, for concentrating the light emitted from the light source into a cone of light rays;
wherein the two lenses and the light source are arranged along an optical axis and the primary lens is located between the light source and the secondary lens, and the distance between the primary lens and the secondary lens along the optical axis is variable, in order to vary the angle of emission of the cone of light rays,
wherein the primary lens has a numerical aperture of at least 0.7, the primary lens is an aplanat, and the secondary lens is designed so as to image to infinity, at a certain distance of the secondary lens from the primary lens, a virtual image of the light source generated by the primary lens.

2. A lighting device according to claim 1, wherein the primary lens is mounted at a predetermined distance from the light source, and that the secondary lens is movable by a distance amounting to the multiple of the distance between primary lens and secondary lens.

3. A lighting device according to claim 1, wherein the primary lens has a numerical aperture of at least 0.9.

4. A lighting device according to claim 1, wherein that the secondary lens is movable by a distance extending in a range in which the secondary lens does not capture the whole of the cone of light rays generated by the primary lens.

5. A lighting device according to claim 1, wherein the primary lens and the secondary lens each have in their centers a concave entrance surface and a convex exit surface.

6. A lighting device according to claim 5, wherein the exit surface of the primary lens is more curved than the exit surface of the secondary lens.

7. A lighting device according to claim 1, wherein the lens system comprises exactly, and only two lenses.

8. A lighting device according to claim 1, wherein the primary lens is formed of a central condenser lens section and an annular lens section surrounding the condenser lens section and having a sheath section at which light entering the primary lens is totally reflected at the boundary.

9. A lighting device according to claim 1, wherein the primary lens is formed of a central focusing lens section and a deflecting ring section surrounding the focusing lens section and deflecting at right-angles to the optical axis light entering the primary lens at the boundary.

10. A lighting device according to claim 1, wherein it has an array of light sources, an array of primary lenses and an array of secondary lenses, in which each light source is assigned a primary lens and a secondary lens.

11. A lighting device according to claim 10, wherein a pinhole diaphragm with several apertures is provided between the array of primary lenses and the array of secondary lenses, while each secondary lens is assigned an aperture of the pinhole diaphragm.

12. A lighting device according to claim 10, wherein the array of light sources has as light sources light-emitting diodes, each having a rectangular emitting surface, with the light-emitting diodes each rotated a little from one another when viewed from above.

13. A lighting device according to claim 10, wherein the light sources are designed to emit cones of light rays of different colour.

14. A lighting device with variable angle of emission, comprising:
a light source; and
a lens system comprising two lenses, a primary lens and a secondary lens, for concentrating the light emitted from the light source into a cone of light rays,
wherein the two lenses and the light source are arranged along an optical axis and the primary lens is located between the light source and the secondary lens, and the distance between the primary lens and the secondary lens along the optical axis is variable, in order to vary the angle of emission of the cone of light rays,
wherein the primary lens has a numerical aperture of at least 0.7, the secondary lens is movable by a distance extending in a range in which the secondary lens does not capture the whole of the cone of light rays generated by the primary lens.

15. A lighting device according to claim 14, wherein the primary lens is mounted at a predetermined distance from the light source, and that the secondary lens is movable by a distance amounting to the multiple of the distance between primary lens and secondary lens.

16. A lighting device according to claim 14, wherein the primary lens has a numerical aperture of at least 0.9.

17. A lighting device according to claim 14, wherein that the secondary lens may be moved by a distance extending in a range in which the secondary lens does not capture the whole of the cone of light rays generated by the primary lens.

18. A lighting device according to claim 14, wherein the primary lens and the secondary lens each have in their centres a concave entrance surface and a convex exit surface.

19. A lighting device according to claim 18, wherein the exit surface of the primary lens is more curved than the exit surface of the secondary lens.

20. A lighting device according to claim 14, wherein the primary lens is corrected aplanatically.

21. A lighting device according to claim 14, wherein the lens system comprises exactly two lenses.

22. A lighting device according to claim 14, wherein the primary lens is formed of a central condenser lens section and an annular lens section surrounding the condenser lens section and having a sheath section at which light entering the primary lens is totally reflected at the boundary.

23. A lighting device according to claim 14, wherein the primary lens is formed of a central condenser lens section and a deflecting ring section surrounding the condenser lens section and deflecting at right-angles to the optical axis light entering the primary lens at the boundary.

24. A lighting device according to claim 14, wherein it has an array of light sources, an array of primary lenses and an array of secondary lenses, in which each light source is assigned a primary lens and a secondary lens.

25. A lighting device according to claim 24, wherein a pinhole diaphragm with several apertures is provided between the array of primary lenses and the array of secondary lenses, while each secondary lens is assigned an aperture of the pinhole diaphragm.

26. A lighting device according to claim 24, wherein the array of light sources has as light sources light-emitting diodes, each having a rectangular emitting surface, with the light-emitting diodes each rotated a little from one another when viewed from above.

27. A lighting device according to claim 24, wherein the light sources are designed to emit cones of light rays of different colour.
